(19) United States
(12) Patent Application Publication
(10) Pub. No.: US 2004/0266424 A1
(43) Pub. Date: Dec. 30, 2004

(54) Method and apparatus for interfacing wired and wireless data

(76) Inventors: Jao-Hong Park, Suwon-si (KR); Seung-Soo Oak, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/835,005

(22) Filed: Apr. 30, 2004

(30) Foreign Application Priority Data
Jun. 26, 2003 (KR) 2003-42114

(51) Int. Cl. H04Q 7/20

(52) U.S. Cl. 455/426.1

(57) ABSTRACT

A method and apparatus for interfacing wired data and wireless data are provided. The method of interfacing wired data and wireless data includes determining whether connection to both the wired network and the wireless network is required for interfacing the wired data and the wireless data. If it is determined that connection to both the wired network and the wireless network is required, the network electronic device operates in a wired/wireless network mode for interfacing both the wired data and the wireless data, and interfaces the wired data and the wireless data, preferably using the same MAC and IP address for both the wired data interface and the wireless data interface.

This application claims the benefit under 35 U.S.C. §119(a) of Korean Patent Application No. 2003-42114, filed on Jun. 26, 2003, in the Korean Intellectual Property Office, the entire disclosure of which is hereby incorporated reference.

### BACKGROUND OF THE INVENTION

1. Field of the Invention

The present invention relates to interfacing data between network electronic devices, such as computers, printers, or multifunctional devices. More particularly, the present invention relates to a method and apparatus for interfacing wired data and wireless data, which connect a wired network and a wireless network.

2. Description of the Related Art

Unlike wired communications which use physical media, such as cables, conventional wireless networks are implemented with various types of wireless communication, such as a wireless local area network (hereinafter, referred to as a wireless LAN), Bluetooth, or infrared data association (IrDA). In particular, wireless networks using a wireless LAN are implemented with two methods as follows. In the first method, which entails wireless networks using an ad-hoc mode, wireless networks are implemented with electronic network devices where each device has a wireless LAN card. Wireless networks using an ad-hoc mode refers to the fact that these types of wireless networks are implemented using a peer-to-peer method. In the second method, which entails wireless networks using an infra-structure mode, wireless networks are implemented with access points. The infra-structure mode is used together with a conventional wired LAN, and in the infra-structure mode, wireless networks can be implemented using access points.

It is desirable for conventional network electronic devices to have both a wireless network card and a wired network card, so that simultaneous connections to a wireless network and a wired network can be achieved. Alternatively, conventional network electronic devices may have a wired/wireless network card that can be used in both a wired network and a wireless network.

However, when a wireless network card and a wired network card are provided in conventional network electronic devices, a MAC address for each of the wireless network card and the wired network card needs to be managed, and an Internet protocol (IP) address needs to be allocated to each of the wireless network card and the wired network card. In addition, conventional network electronic devices require both a wireless network card and a wired network card to access both types of networks, and thus, are more expensive.

Meanwhile, when conventional network electronic devices have a wired/wireless network card that can be used in both a wired network and a wireless network, connection to a wired or wireless network is possible using one MAC address and one IP address. However, when a wired/wireless network card is provided in a conventional network electronic device, only one type of connection can be active at one time. Thus, if a mode for a wired network is set, connection to a wireless network is not possible. If a mode for a wireless network is set, connection to a wired network is not possible. Accordingly, the wired/wireless network card cannot be connected to a wired network and a wireless network simultaneously.

### SUMMARY OF THE INVENTION

The present invention provides a method and apparatus for interfacing wired data and wireless data, which connects a wired network and a wireless network using a single network card.

According to an aspect of the present invention, there is provided a method of interfacing wired and wireless data transmitted via a wired network or a wireless network in a network electronic device, the method comprising determining whether connection to both the wired network and the wireless network is required for interfacing the wired data and the wireless data, if it is determined that connection to both the wired network and the wireless network is required, operating the network electronic device in a wired/wireless network mode for interfacing both the wire data and the wireless data, and interfacing the wired data and the wireless data.

According to another aspect of the present invention, there is provided an apparatus for interfacing wired data and wireless data transmitted via a wired network or a wireless network in a network electronic device, the apparatus comprising a wired interface unit for connecting the network electronic device to another network electronic device via the wired network, a wireless interface unit for connecting the network electronic device to another network electronic device via the wireless network, a network controller for controlling the network electronic device to transmit the wired data and the wireless data in a wired/wireless network mode, and a data storage unit for storing the wired data and the wireless data input via the wired network and the wireless network.

### BRIEF DESCRIPTION OF THE DRAWINGS

The above and other aspects and advantages of the present invention will become more apparent by describing in detail embodiments thereof with reference to the attached drawings in which:

FIG. 1 is a flowchart showing a method of interfacing wired data and wireless data according to an embodiment of the present invention;

FIG. 2 is a flowchart showing a process of interfacing wired data and wireless data according to the method illustrated in FIG. 1;

FIG. 3 is a block diagram showing a structure of an apparatus for interfacing wired data and wireless data according to an embodiment of the present invention; and

FIG. 4 is a block diagram showing a network controller according to the embodiment of the present invention illustrated in FIG. 3.

Throughout the drawings, it should be understood that like reference numerals are intended to refer to like features and structures.

### DETAILED DESCRIPTION OF THE INVENTION

Hereinafter, an exemplary embodiment of the present invention will be described in detail with reference to the accompanying drawings.

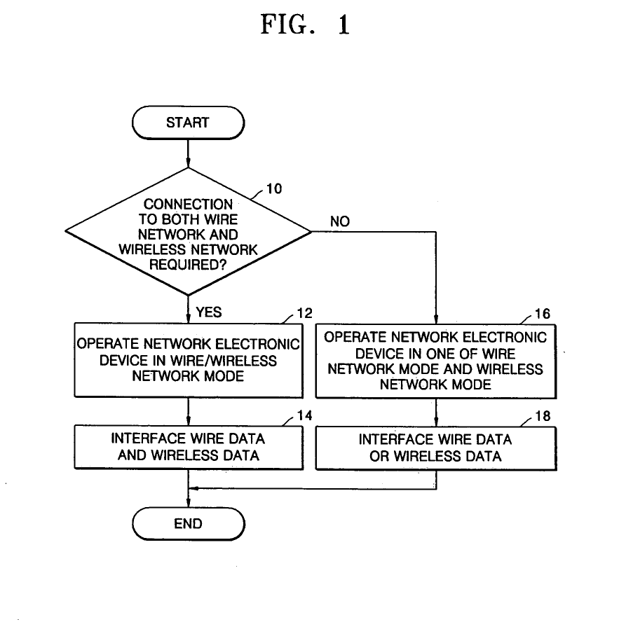

FIG. 1 is a flowchart showing a method of interfacing wired data and wireless data according to an embodiment of the present invention. Referring to FIG. 1, the method of interlacing wired data and wireless data includes interfacing wired data and wireless data depending on whether connections to both a wired network and a wireless network are required (steps 10 through 18).

First, in step 10, it is determined whether connections to both a wired network and a wireless network are required for interfacing wired data and wireless data. Connections to both a wired network and a wireless network are required in accordance with a user's or a network manager's selection by driving a network management program. If the network management program is driven, a network electronic device for connection to both a wired network and a wireless network is designated by a user or a network manager. Subsequently, the user or the network manager determines whether connection to both a wired network and a wireless network is required for the designated network electronic device. The user or the network manager allocates a service set identification (SSID) to a wireless network while determining whether there is a need for connection to both the wired network and the wireless network. The result concerning whether connection is required, which is determined by the user, is transmitted to the designated network electronic device. The result of transmission is used as determination data on whether connection to both a wired network and a wireless network is required. For example, a printer corresponding to the network electronic device determines whether connection to both a wired network and a wireless network transmitted from the computer is required.

If it is determined that connections to both a wired network and a wireless network are required, the network electronic device operates in a wired/wireless network mode for interfacing both wired data and wireless data (step 12). The wired/wireless network mode is a network control mode for interfacing wired data via a wired network and interfacing wireless data via a wireless network. A network environment using a wired LAN and a network environment using a wireless LAN should be provided to the network electronic device so that the network electronic device operates in a wired/wireless network mode. To this end, the network electronic device includes a wired/wireless data interface device, which connects to both a wired network and a wireless network, such as a wired/wireless network card. The network environment using the wireless LAN is set in an ad-hoc mode. The wired/wireless network card, which is connected to both the wired network and the wireless network, has one MAC address and one IP address. The wireless network using the ad-hoc mode refers to the fact that a wireless network is implemented using a peer-to-peer method, as described above. Environments for a wired network and a wireless network are constructed using the same MAC address and the same IP address.

After step 12, in step 14, wired data and wireless data are interfaced. As the network electronic device operates in a wired/wireless network mode, the wired data is interfaced via a wired network, and the wireless data is interfaced via a wireless network.

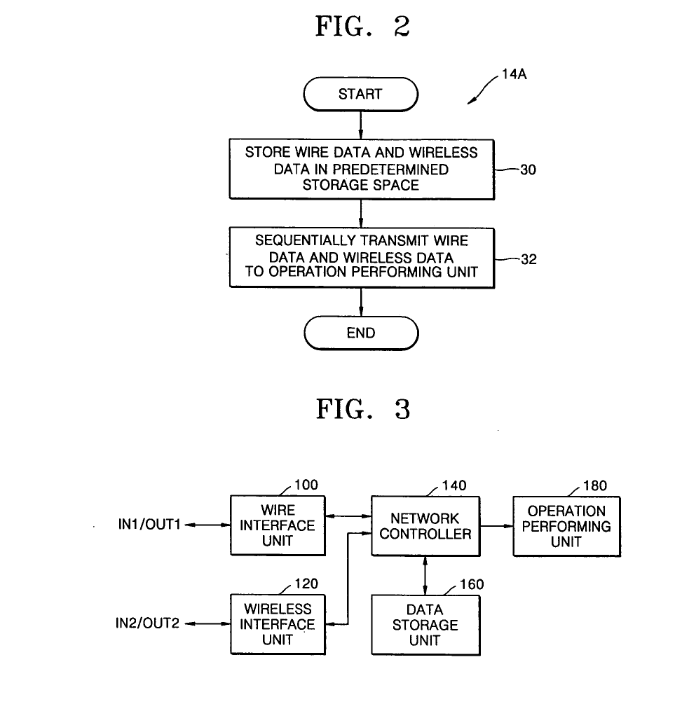

FIG. 2 is a flowchart showing step 14 of the method of interfacing wired data and wireless data according to an embodiment of the present invention, as shown in FIG. 1. Referring to FIG. 2, the process 14 includes sequentially transmitting wired data and wireless data stored in a predetermined storage space to an operation performing unit (steps 30 and 32). The operation performing unit performs a predetermined function of the network electronic device. For example, when the network electronic device is a printer, the operation performing unit performs a printing operation of the printer, and when the network electronic device is a scanner, the operation performing unit scans an image, and when the network electronic device is a commonly-used computer, the operation performing unit performs data processing, such as an arithmetic operation and a logic operation, on data.

First, in process 30, wired data and wireless data transmitted via the wired network and the wireless network are stored in a predetermined storage space. The wired and the wireless data transmitted via the wired network and the wireless network are primarily stored in the predetermined storage space. As an example, a dynamic RAM (DRAM) may be used as the predetermined storage space. However, as will be readily understood, any suitable data storage device may be used instread of dynamic RAM. Preferably, the predetermined storage space has a sufficiently large memory capacity for storing both the wired data and wireless data.

After step 30, in step 32, the wired data and wireless data stored in the predetermined storage space are sequentially transmitted to the operation performing unit. In other words, if the wired data is first stored in the predetermined storage space and the wireless data is then stored therein, the wired data is first transmitted to the operation performing unit, and the wireless data is then transmitted to the operation performing unit. The wired data and wireless data are transmitted to the operation performing unit using a direct memory access method. In the direct memory access method, data transmission is directly performed between a predetermined storage space and an operation performing unit at a high speed without passing a CPU.

Meanwhile, if it is determined that connection to both a wired network and a wireless network is not required, in step 16 (see FIG. 1), the network electronic device operates in one of a wired network mode and a wireless network mode for interfacing with either wired data or wireless data. When connection to both the wired network and the wireless network is not required, data only needs to be interfaced via one of the wired network and the wireless network. Thus, if connection to the wired network is required, the network electronic device operates in the wired network mode, and if connection to the wireless network is required, the network electronic device operates in the wireless network mode.

After step 16, in step 18, the wired data or the wireless data is interfaced. As the network electronic device operates in the wired network mode, if the wired data is transmitted via the wired network, the wired data is stored in the above-described storage space and transmitted to the operation performing unit. Similarly, as the network electronic device operates in the wireless network mode, if the wireless data is transmitted via the wireless network, the wireless data is stored in the above-described storage space and transmitted to the operation performing unit.

Hereinafter, an apparatus for interfacing wired data and wireless data according to an embodiment of the present invention will be described with reference to the accompanying drawings.

FIG. 3 is a block diagram showing a structure of an apparatus for interfacing wired data and wireless data according to an embodiment of the present invention. Referring to FIG. 3, the apparatus for interfacing wired data and wireless data according to the embodiment of the present invention includes a wired interface unit 100, a wireless interface unit 120, a network controller 140, a data storage unit 160, and an operation performing unit 180.

The wired interface unit 100 connects a network electronic device to another network electronic device via a wired network. The wired interface unit 100 interfaces wired data input into an input terminal IN1 or output from an output terminal OUT1 between the network electronic devices.

The wireless interface unit 120 connects the network electronic device to another network electronic device via a wireless network. The wireless interface unit 120 interfaces wireless data input into an input terminal IN2 or output from an output terminal OUT2 between the network electronic devices.

The above-described wired interface unit 100 and wireless interface unit 120 operate using the same network address. In other words, the wired interface unit 100 and the wireless interface unit 120 share the same MAC address or IP address to enable connection to both the wired network and the wireless network using only one MAC address and one IP address.

The network controller 140 controls the network electronic device to transmit wired data or wireless data to the operation performing unit 180 in a wired/wireless network mode. The network controller 140 controls the network electronic device to store the wired data and wireless data received from the wired interface unit 100 and the wireless interface unit 120 in the data storage unit 160 and to sequentially transmit the wired/wireless data to the operation performing unit 180.

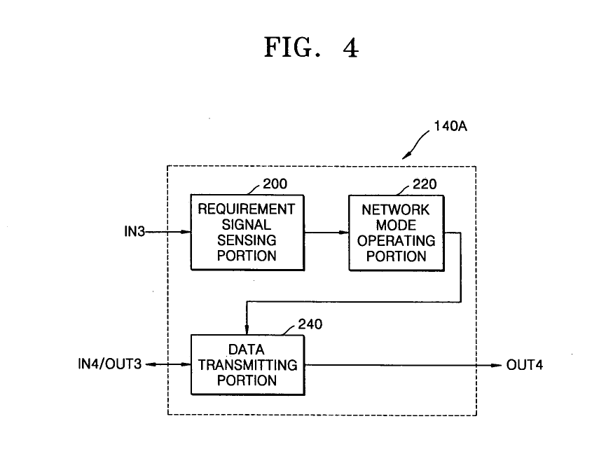

FIG. 4 is a block diagram showing a network controller 140 according to the embodiment of the present inventionilllustrated in FIG. 3. Referring to FIG. 4, the network controller 140 includes a requirement signal sensing portion 200, a network mode operating portion 220, and a data transmitting portion 240.

The requirement signal sensing portion 200 senses a requirement signal for connection to both a wired network and a wireless network or a requirement signal for connection to either the wired network or the wireless network. The requirement signal for connection to both the wired network and the wireless network is input via the wired network and the wireless network. The requirement signal sensing portion 200 senses the requirement signal for connection to both the wired network and the wireless network input into an input terminal IN3 and outputs a sensing result to the network mode operating portion 220. In addition, the requirement signal sensing portion 200 senses the requirement signal for connection to one of the wired network and the wireless network input into the input terminal IN3 and outputs a sensing result to the network mode operating portion 220.

The network mode operating portion 220 operates in a wired/wireless network mode for interfacing both wired data and wireless data, or in one of a wired network mode and a wireless network mode for interfacing either the wired data or the wireless data. The network mode operating portion 220 operates in the wired/wireless network mode for interfacing both the wired data and the wireless data between the network electronic devices and transmits a first operational signal for the wired/wireless network mode to the data transmitting portion 240 in response to the requirement signal for connection to both the wired network and the wireless network input from the requirement signal sensing portion 200. In the network electronic device, the wired data and the wireless data are interfaced via the wired network and the wireless network in response to the first operational signal. The network mode operating portion 220 operates in a wireless network mode or an ad-hoc mode when operating in the wired/wireless network mode.

Meanwhile, the network mode operating portion 220 operates in the wired network mode or the wireless network mode for interfacing either the wired data or the wireless data and transmits a second operational signal for the wired network mode or the wireless network mode to the data transmitting portion 240 in response to the requirement signal for connection to one network input from the requirement signal sensing portion 200. If the second operational signal is an operational signal for the wired network mode, in the network electronic device, the wired data is interfaced via the wired network in response to the second operational signal. Meanwhile, if the second operational signal is an operational signal for the wireless network mode, in the network electronic device, the wireless data is interfaced via the wireless network.

The data transmitting portion 240 sequentially transmits the wired data and the wireless data stored in the data storage unit 160 to the operation performing unit 180. The data transmitting portion 240 requests the wired data and the wireless from the data storage unit 160 via an output terminal OUT3 in response to the first operational signal. The data transmitting portion 240 receives the requested wired data and wireless data from an input terminal IN4 and outputs the wired data and the wireless data to an output terminal OUT4. The wired data and the wireless data are sequentially withdrawn in the order in which they were stored in the data storage unit 160 and transmitted to the operation performing unit 180. The data transmitting portion 240 transmits the wired data and the wireless data using the direct memory access method. In addition, the data transmitting portion 240 requests one of the wired data and the wireless data from the data storage unit 160 via the output terminal OUT3 in response to the second operational signal. The data transmitting portion 240 receives one of the requested wired data and wireless data from the input terminal IN4 and outputs one of the wired data and wireless data to the output terminal OUT4.

The data storage unit 160 stores the wired data and the wireless data input via the wired network and the wireless network. The data storage unit 160 stores the input wired data and wireless data in a predetermined storage space, such as a DRAM. In addition, the data storage unit 160 sequentially outputs the stored wired data and wireless data to the operation performing unit 180 in response to a data request signal of the data transmitting portion 240

The operation performing unit 180 performs a predetermined function of the network electronic device, as described above. For example, the operation performing unit 180 may be a unit for performing a printing operation in a printer, scanning an image in a scanner, or performing data processing in a commonly-used computer.

As described above, the method and apparatus for interfacing wired data and wireless data according to an embodiment of the present invention connects a wired network and a wireless network using one network card such that interfacing of wired data and wireless data is performed using only one network address in a network electronic device.

While this invention has been particularly shown and described with reference to a preferred embodiment thereof, it will be understood by those skilled in the art that various changes in form and details may be made therein without departing from the spirit and scope of the invention as defined by the appended claims and equivalents thereof.

What is claimed is:

1. A method of interfacing wired data and wireless data transmitted via a wired network or a wireless network in a network electronic device, the method comprising:
(a) determining whether connection to both the wired network and the wireless network is required for interfacing the wired data and the wireless data;
(b) if it is determined that connection to both the wired network and the wireless network is required, operating the network electronic device in a wired/wireless network mode for interfacing both the wired data and the wireless data; and
(c) interfacing the wired data and the wireless data.

2. The method of claim 1, further comprising:
(d) if it is determined that connection to both the wired network and the wireless network is not required, operating the network electronic device in one of a wired network mode and a wireless network mode for interfacing one of the wired data and the wireless data; and
(e) interfacing one of the wired data and the wireless data.

3. The method of claim 1, wherein in step (b), when the network electronic device operates in the wired/wireless network mode, the network electronic device operates in an ad-hoc mode of a wireless network mode.

4. The method of claim 1, wherein step (c) comprises:
(c1) storing the wired data and the wireless data transmitted via the wired network and the wireless network in a predetermined storage space; and
(c2) sequentially transmitting the wired data and the wireless data stored in the predetermined storage space to an operation performing unit performing a predetermined function of the network electronic device.

5. The method of claim 4, wherein in (c2), the wired data and the wireless data are transmitted to the operation performing unit using a direct memory access method.

6. An apparatus for interfacing wired data and wireless data transmitted via a wired network or a wireless network in a network electronic device, the apparatus comprising:
a wired interface unit for connecting the network electronic device to another network electronic device via the wired network;
a wireless interface unit for connecting the network electronic device to another network electronic device via the wireless network;
a network controller for controlling the network electronic device to transmit the wired data and the wireless data in a wired/wireless network mode; and
a data storage unit for storing the wired data and the wireless data input via the wired network and the wireless network.

7. The apparatus of claim 6, wherein the wired interface unit and the wireless interface unit operate using the same network address.

8. The apparatus of claim 7, wherein the network address comprises one MAC address and one IP address.

9. The apparatus of claim 6, wherein the network controller comprises:
a requirement signal sensing portion for sensing a requirement signal for connection to both the wired network and the wireless network or a requirement signal for connection to one of the wired network and the wireless network;
a network mode operating portion for operating in a wired/wireless network mode for interfacing both the wired data and the wireless data or one of a wired network mode and a wireless network mode for interfacing one of the wired data and the wireless data; and
a data transmitting portion for sequentially transmitting the wired data and the wireless data stored in the data storage unit to an operation performing unit performing a predetermined function of the network electronic device.

10. The apparatus of claim 9, wherein the network mode operating portion operates in an ad-hoc mode of a wireless network mode when operating in the wired/wireless network mode.

11. The apparatus of claim 9, wherein the data transmitting portion transmits the wired data and the wireless data to the operation performing unit using a direct memory access method.
